(19) United States
(12) Patent Application Publication
(10) Pub. No.: US 2005/0157349 A1
(43) Pub. Date: Jul. 21, 2005

(54) Print ready document management for distributed printing

(75) Inventors: Donald M. Pangrazio, Leroy, NY (US); Edward E. Brindle, Victor, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/759,638

(22) Filed: Jan. 16, 2004

(51) Int. Cl. H04N 1/32; G06F 17/30

(52) U.S. Cl. 358/442; 707/1

(57) ABSTRACT

A method of publishing multi-site print ready document libraries using a “published subscribe” methodology and synchronizing documents with subscribers by communicating via multicast over a data network. The use of “publish” and “subscribe” allows for jobs or documents to be assigned to specific topics or subjects. An individual site that is interested in a subject can subscribe to the subject and receive updates automatically via specific data synchronization. This allows the site to share only the necessary data to specific sites. A system for enabling topic library publication, topic subscription, and topic-related data synchronization by multicast is also described.

### FIELD OF THE INVENTION

The present invention is generally related to print ready document management, distribution and printing. More particularly, the present invention is related to publishing print ready document libraries using a “publish and subscribe” relationship, and is also related to synchronizing subscription information with remote subscribers by multicasting print ready documents over a data network.

### BACKGROUND

As networks and systems become more integrated and more complex, the amount and speed of information flow between users creates a need for more versatile and more efficient control over the information flow process. For print service providers with multiple production sites,,the issue is how to best leverage and utilize technology to take advantage of the multiple sites.

The following Xerox Corporation U.S. patents include examples of systems indicating multicast communications utilizing a network, server and including rendering equipment (e.g., printers) usually having shared remote user terminals: U.S. Pat. Nos.: 6,557,111, 5,513,126 and 5,305,311. Protocols defining integrated system behavior for devices such as printers, scanners, workstations and facsimiles, are well known. These protocols define how the systems should integrate across networks. Operational transparency across networks and device platforms, provide users with an increasingly integrated and transparent system environment. In this environment the manipulation of information (such as documents) is transparent to users as a result of the various network protocols that define the manner in which devices manipulate information.

Printers (and printer controllers or servers) are also sometimes referred to as “shared resources” in a networked environment. The server typically functions as a “spooler” to buffer the jobs that are sent to it, as well as a page description language (PDL) “decomposer”, for converting the PDL files (e.g., “Interpress™” or “PostScript®”) to bitmapped files for application to the printer. Also of interest is Pennant Systems Co., Print Services Facility/2 (PFS/2), server-based software intended to act as a universal translator between various network protocols (LAN, TCP/IP and SNA) and printer document protocols (PCL and Postcript). Extensible Markup Language (XML) is also a familiar document transmission and conversion protocol.

Different workstations can access print services in different ways. Workstation selectable print options can include the number of copies, selected pages to be printed, paper size, image orientation, a choice of printers, and phone numbers when sending to a facsimile device. Already print-formatted or master documents may be transmitted to the printer directly, eliminating the need to repeat the conversion or decomposition process if another copy of the document is desired. If saved, a master file can be stored at the file service or even mailed to one or more individuals via an electronic mail service. Utilizing an internetwork routing service, users can transmit a document through a network and then across an internet, typically, via telephone lines, twisted pair wires, coaxial cables, microwaves, infrared, and/or other data links, allowing documents created in one location to be automatically routed to a print service and printer hundreds or even thousands of miles away, in seconds or minutes.

Having multiple sites brings up issues such as fail-over, redundancy/backup, and load balancing. Each location may have specific expertise in preparing jobs, proofing jobs, and producing jobs, but where the print service provider decides to master or print a job may depend on multi-site load balancing, the expertise required, and the shipping and labor costs. For these reasons, it is desirable to have the ability to master and print at multiple sites at any given time. In such cases, the print service provider would likely want to have specific jobs (not necessarily all jobs) ready to print at multiple locations.

Due to the steps involved in preparing and proofing a job, prepared print ready files are usually what are needed at each site. Although present systems may enable the management of source PDLs, storing the PDL induces additional point of failure because the ripping/processing of the PDL can produce different results depending upon several factors.

Manually moving print ready files from site to site, whether on media or over a network, becomes prohibiting when the amount of data and frequency increases. Centrally storing the print ready files is not an option due to: the speed at which it needs to be retrieved to run at rated printer speed; the amount of network traffic it would cause; the general lack of redundancy/backup. Furthermore, traditional methods of synchronizing document libraries are intrusive; services must be shut down while the data is being uploaded. They are also non-scalable, and do not occur in real-time.

Currently, Xerox Corporation's Custom Print Solution (CPS) uses an open-source product called “rsync.” The product can replicate an entire library or update the deltas. The problem with rsync is that it has to be scheduled to run at a certain time and while it is running, CPS's Repository services have to be disabled. The time to run rsync can be in the vicinity of two hours to synchronize two print sites. Currently this is done between shifts. As the libraries grow and as an enterprise scales from two to multiple sites, the time to resynchronize libraries will become a problem. Synchronization processes can quickly consume an entire workshift or more. Archive tapes are also known to be used, but can pose even more problems for the enterprise.

What is needed are improved systems and methods for manage distributed multi-site Print Ready Document libraries utilizing available data communications networks.

### SUMMARY OF THE INVENTION

The present invention includes a method of synchronizing multi-site Print Ready Document Libraries using a “publish and subscribe” relationship, and methods of communicating over a multicast enabled messaging system.

In accordance with features of the present invention, the use of a multicast communication transport layer avoids the network bottleneck, which would otherwise occur when transmitting large amounts of data in a point-to-point fashion. Furthermore, use of “publish and subscribe” allows for jobs (or documents) to be assigned to specific topics or subjects.

In accordance with an aspect of the present invention, subjects are predefined and each site which is interested in a subject expresses the interested through subscribing to the subject. Any site that publishes to the subject is assured that all sites that have presubscribed will receive the data. This allows a site to share only the necessary data to the necessary sites.

It is a feature of the present invention that the systems and processes enable sharing of specific print ready documents with other specific sites in an efficient manner such that the organization as a whole has the competitive advantage of being able to print the job in multiple sites.

### BRIEF DESCRIPTION OF THE DRAWINGS

FIG. 1, is a block diagram of a system in accordance with a preferred embodiment of the present invention.

FIG. 2, is a flow diagram of a method in accordance with a preferred embodiment of the present invention.

### DETAILED DESCRIPTION OF PREFERRED EMBODIMENTS

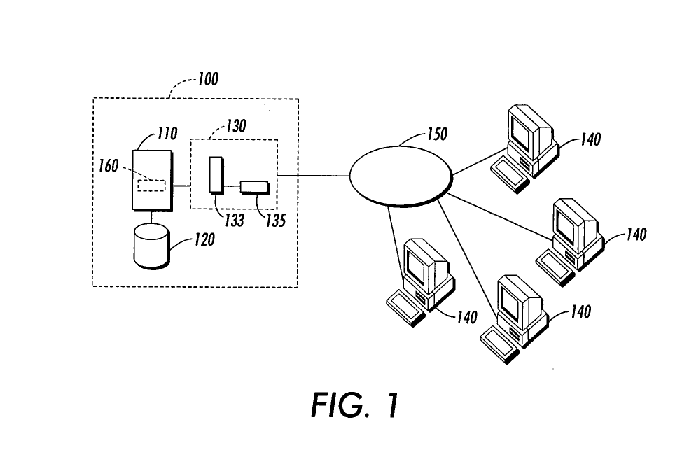

Referring to FIG. 1, a block diagram of a system 100 for enabling the multicast publication, subscription and synchronization of data is shown. The system 100 includes access to a data network 150, at least one server 110 providing access to topical information stored in at least one database 120 via enterprise communication equipment 130. The system communicates with more than one client 140 located at remote locations and also having access to a data network 150. The communication equipment 130 will include such items as a router 133 and a network access device 135 (e.g., modems) to provide access to the network 150. Publish-subscribe middleware 160 enables the at least one server 110 and at least one database 120 to operate together for the management of subscriber data, topic data and publication-subscription logs.

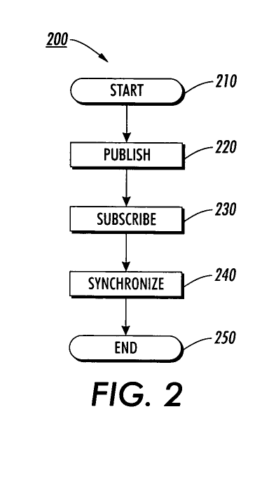

Referring to FIG. 2, a flow diagram 200 of a method in accordance with a preferred embodiment of the invention is illustrated. A method of synchronizing multi-site print ready document libraries begins at block 210. Referring to block 220, document library subject availability is published via multicast communication over a data network. Referring to block 230, subscriptions for document library subjects are received over the data network from remote subscribers at individual sites. At block 240, data representative of the document is periodically synchronized over the data network with remote subscribers located at individual sites. The process ends at block 250.

Jobs can be assigned to subjects and can also represent documents for publication that are associated with the topics. It should be appreciated that remote subscribers at individual sites interested in a subject can subscribe to the subject and receive document updates automatically, wherein only necessary data related to the subject is necessarily synchronized with the remote subscribers located at specific sites. Communication is all accomplished via multicast to subscribers by publisher enterprise equipment.

Use of a multicast communication transport layer avoids the network bottleneck, which would otherwise occur when transmitting large amounts of data in a point-to-point fashion. The use of “publish and subscribe” allows for jobs (or documents) to be assigned to specific topics or subject. Subjects are predefined, and each site that is interested in a subject expresses the interest through subscribing to the subject. This is accomplished through a configuration file that acts as a lookup table for the subjects that a given site is interested in receiving. When the software is initialized at a given site, it communicates what subjects it is interested in based on the information in its own configuration file.

The publish-subscribe middleware 160 keeps track of what sites are subscribed to what subject. Any site that publishes to a given subject is assured that all sites which have pre-subscribed to the subject will receive the data. This allows a site to share only the necessary data to the necessary sites. Network traffic is thus minimized so that only interested parties receive data and the data is only transmitted across a given path once in a one-to-many multicast fashion.

As an example of how the invention worked, XYZ is the print service provider. There are four print service sites across the country, which are referred to as DTC1-DTC4. The Catholic Church is one customer and bears a name associated with its own subject—CATHOLIC. The US Department of Defense is another customer and has two subjects DODARMY and DODNAVY. In this example DTC and DTC4 subscribe to CATHOLIC. DTC1 and DTC2 subscribe to DODARMY. DTC2 and DTC3 subscribe to DODNAVY. Note that the DOD subjects are named such that the wildcard “DOD*” will be published to any DODNAVY or DODARMY site.

The following is a summary of which subscriber will be allowed to perform work for a given subject:

| Subject | Valid Sites |
|---|---|
| CATHOLIC | DTC1, DTC4 |
| DOD* | DTC1, DTC2, DTC3 (where “*” is a wildcard) |
| DODARMY | DTC1, DTC2 |
| DODNAVY | DTC2, DTC3 |

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of synchronizing multi-site print ready document libraries, comprising:
publishing document library subject availability via multicast communication over a data network;
receiving subscriptions for document library subjects over the data network from remote subscribers at individual sites; and
instantaneously, at time of repository change, synchronizing data representative of the document with remote subscribers at individual sites over the data network.

2. The method of claim 1 wherein jobs are assigned to subjects.

3. The method of claim 2 wherein said jobs include documents.

4. The method of claim 3 wherein said jobs are documents.

5. The method of claim 1, wherein remote subscribers at individual sites interested in a subject can subscribe to the subject and receive document updates automatically, wherein only necessary data related to the subject is synchronized with the remote subscribers at specific sites.

6. A method of synchronizing multi-site print ready document libraries, comprising:
publishing document library subject availability via multicast communication over a data network; and
receiving subscriptions for document library subjects over the data network from remote subscribers at individual sites.

7. The method of claim 6 further comprising instantaneously synchronizing data representative of the document with remote subscribers at individual sites over the data network.

8. The method of claim 7 wherein jobs are assigned to subjects.

9. The method of claim 8 wherein said jobs include documents.

10. The method of claim 8 wherein said jobs are documents.

11. The method of claim 7, wherein remote subscribers at individual sites interested in a subject can subscribe to the subject and receive document updates automatically, wherein only necessary data related to the subject is synchronized with the remote subscribers at specific sites.

12. A system for multi-site print ready document library synchronization via multicast, comprising:
at least one server having access to a data network;
at least one database containing documents associated with a print ready document library and the print ready document library; and
software contained in at least one of server, said software for: managing the publication of print ready document library information to multiple subscribers over the data network, accepting document library subscription from the multiple subscribers, and synchronization of print ready document library and documents associated with the library with the multiple subscribers from the database through the server and the network to multiple subscriber equipment.

13. The system of claim 12, further comprising communication equipment associated with the server for enabling multicast communication with the multiple subscribers over the data network.
